(19) United States
(12) Patent Application Publication
(10) Pub. No.: US 2018/0293995 A1
(43) Pub. Date: Oct. 11, 2018

(54) AMBIENT NOISE SUPPRESSION

(71) Applicant: Microsoft Technology Licensing, LLC, Redmond, WA (US)

(72) Inventors: Christian Markus Makela, Redmond, WA (US); Christopher Borowski, Bellevue, WA (US); Chintan M. Bakshi, Redmond, WA (US)

(21) Appl. No.: 15/479,902

(22) Filed: Apr. 5, 2017

(51) Int. Cl. G10L 21/0232; G10L 25/21; G10L 25/51

(52) U.S. Cl. CPC G10L 21/0232; G10L 25/51; G10L 25/21

(57) ABSTRACT

Ambient noise can be suppressed from a captured audio signal by detecting a parameter of a variable ambient noise source and determining a first power spectrum representing the variable ambient noise source based on the detected parameter. If the first power spectrum is compared to a second power spectrum that is determined for the captured audio signal, the two power spectra can be compared to identify a frequency range where net power of the first power spectrum and net power of the second power spectrum satisfy relativity criteria. Suppressing the audio signal within the identified frequency range has the effect of reducing degradation of a voice communication present in the audio signal.

### BACKGROUND

Personal computing devices electronics are being used with increasing frequency to transmit and receive voice communications. When compared to more traditional communication devices (e.g., landline phones), these personal computing devices may be susceptible to an increased risk of exposure to ambient noise that can degrade the quality of voice communications. For example, a mobile computing device is more likely to be used in a noisy environment than a traditional landline phone. Further, some multi-purpose electronics include components that themselves produce ambient noise.

### SUMMARY

Implementations described and claimed herein facilitate suppression of ambient noise from a captured audio signal by detecting a parameter of a variable ambient noise source; determining a first power spectrum representing the variable ambient noise source based on the detected parameter; determining a second power spectrum representing the captured audio signal; and comparing the first power spectrum to the second power spectrum to identify at least one frequency range where net power of the first power spectrum and net power of the second power spectrum satisfy relativity criteria. The captured audio signal may then be suppressed within the at least one identified frequency range.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system for suppression of ambient noise from a captured voice communication.

FIG. 2 illustrates another example system for suppression of ambient noise from a captured voice communication.

FIG. 3 illustrates an example plot illustrating a first power spectrum corresponding to an ambient noise source and a second power spectrum corresponding to an input audio signal captured by a microphone.

FIG. 4 illustrates example operations for ambient noise suppression.

FIG. 5 illustrates an example schematic of a processing device suitable for receiving an audio stream and suppressing ambient noise from the stream in select frequency bands.

### DETAILED DESCRIPTION

Audio quality of voice communications can be degraded by ambient noise produced by components internal to a communication device or by sources external to the communication device. Size and/or spacing design constraints for an electronic device may, for example, cause a microphone to be positioned in close proximity to a fan or other moving component that generates noise. In such cases, noise generated by the moving component may be detectable by the microphone. Some electronic devices have multiple fans and/or other components that cause ambient noise.

Removing ambient noise from an audio signal (e.g., a voice communication) can be difficult, particularly when the ambient noise is of a variable frequency. For example, intensity and frequency of fan noise may vary over time due to dynamic variations in rotational fan speed designed to meet cooling standards of a computing device. At higher speeds, fans may generate more detectable noise. The herein disclosed technology provides for prediction of an ambient noise power spectrum based on a dynamically-detected parameter of an ambient noise source. The predicted ambient noise power spectrum can then be compared to a power spectrum representing microphone input to identify frequencies of a voice communication most likely to be impacted (e.g., degraded) by noise generated by the ambient noise source. The disclosed technology further provides for targeted suppression at the identified frequencies to reduce an amount of signal degradation noticeable to an end user.

As used herein, the term “voice communication” refers to intentionally-captured audio information such as a communication intended for immediate transmission to a third party or a communication that is intended for storage and later playback, such as a personal voice memo, self-recorded musical compilation, an audio recording of a business meeting, etc. The examples provided herein discuss suppression of ambient noise primarily with respect to the example of ambient noise produced by a rotating fan. However, it may be appreciated that the disclosed technology may be implemented in the same or a similar manner to suppress ambient noise generated by one or more of a variety of other sources for which an associated power spectrum can be attained or computed, including without limitation noise due to rotation and/or vibration of various motors (e.g., spindle and voice coil motors within hard drive devices), wind (e.g., if wind speed is known or measurable), actuators driving optical camera elements (e.g., auto-focus, Optical Image Stabilization), and noise associated with non-electrical device components, such as noise from a device hinge.

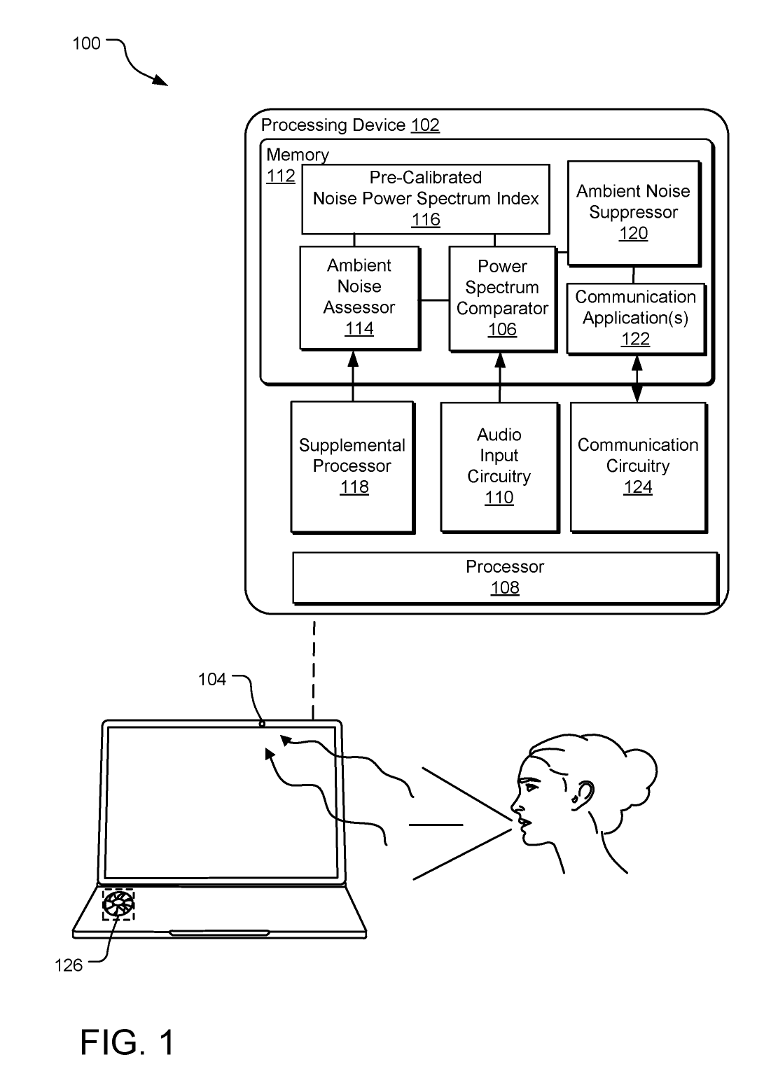

FIG. 1 illustrates an example system 100 for suppressing ambient noise from a voice communication captured by a microphone 104. The system 100 includes a processing device 102 with audio input circuitry 110 including the microphone 104 for collecting audio input from a surrounding environment. The processing device 102 also includes at least one ambient noise source 126 (e.g., a fan) capable of generating noise that is detectable by the microphone 104. In at least one implementation, the ambient noise source 126 is a variable noise source capable of producing noise in one or more dominant frequencies subject to change at different times. Although FIG. 1 illustrates a single fan, other implementations of the system 100 may include multiple variable ambient noise sources. For example, some devices have multiple fans, motors, or other moving components that create noise that the system 100 can identify and suppress from the input signal.

Although the ambient noise source 126 is shown to be within the processing device 102 that includes the microphone 104 for recording a voice communication, the ambient noise source 126 may, in other implementations, be integrated within an electronic device external to the processing device 102, such as within another electronic device that is capable of communicating one or more parameters of the ambient noise source 126 to the processing device 102 over a wired or wireless network. For example, the ambient noise source may be a fan in a smart home air conditioning system with a processor capable of transmitting information about the fan, such as fan speed, to the processing device 102.

In FIG. 1, the processing device 102 includes at least a processor 108, memory 112, and a number of applications stored in the memory 112 and executable by the processor 108 to provide for suppression of ambient noise present within the input signal captured by the microphone 104. Specifically, the processing device 102 includes an ambient noise assessor 114, a power spectrum comparator 106, and an ambient noise suppressor 120 that collaborate to perform various tasks in analyzing and altering an input signal received via the microphone 104 to suppress the ambient noise from the input signal. The processing device 102 additionally includes one or more communication application(s) 122 for controlling communication circuitry 124 to transmit voice communications (e.g., the input signal captured by the microphone 104) to external device(s). Although the communications circuitry 124 is shown within the processing device 102, the communications circuitry 124 may, in other implementations, be external to the processing device 102, such as integrated within a mass storage device to which the processing device 102 is communicatively coupled. Some implementations may not include the communication application(s) 122.

In one implementation, the ambient noise assessor 114 receives data from one or more processing components operation sensor(s) that provide at least one parameter of the ambient noise source 126. In the illustrated implementation where the ambient noise source 126 is a fan, ambient noise assessor 114 receives data indicative of a fan speed from a supplemental processor 118. For example, a thermal processor may provide the ambient noise assessor 114 with current fan power level. Using the fan power level, the ambient noise assessor 114 can determine a corresponding current fan speed. In another implementation, the ambient noise assessor 114 receives a measured parameter of the ambient noise source 126 from a device operation sensor rather than a supplemental processor, such as a speed sensor that provides real-time measurements of a rotational speed of the fan. The ambient noise assessor 114 may periodically request and receive the fan speed when the microphone 104 is in use, such as when the microphone is initially activated for a voice communication and/or every few seconds or milliseconds while the microphone 104 is in use, such as in use by one of the communication application(s) 122 (e.g., Skype®).

Although the supplemental processor 118 is shown within the processing device 102, other implementations of the disclosed technology include the supplemental processor 118 and/or one or more operation sensors at a location external to the processing device 102. For example, the processing device 102 may communicate with another processing device across a network to request and receive a detected parameter of the ambient noise source 126. For example, the processing device 102 may communicate with a smart home air conditioning system to request and retrieve a current fan operating power or fan speed.

Responsive to receipt of the parameter of the ambient noise source 126 (e.g., fan speed), the ambient noise assessor 114 accesses a pre-calibrated noise power spectrum index 116 stored in the memory 112 to retrieve an associated pre-calibrated power spectrum representative of the ambient noise source 126. For example, the pre-calibrated noise power spectrum index 116 may store a listing of noise power spectrums each corresponding to a different fan speed and representing power of the fan operating at that speed. The ambient noise assessor 114 selects an appropriate power spectrum based on the received parameter, which is hereinafter referred to as the “predicted noise power spectrum.” The ambient noise assessor 114 then provides the predicted noise power spectrum to the power spectrum comparator 106 for further analysis.

In another implementation, the ambient noise assessor 114 retrieves the noise power spectrum from an external source, such as by communicating across a network with an external device that includes one or more ambient noise sources detectable by the microphone 104 of the processing device 102. In some implementations, the ambient noise assessor 114 dynamically generates a noise power spectrum corresponding to the received parameter of the ambient noise source and provides the dynamically generated noise power spectrum to the power spectrum comparator 106 for further analysis.

In general, the power spectrum comparator 106 compares the predicted noise power spectrum of the ambient noise source 126 to a power spectrum representative of the input signal received via the microphone 104 to identify frequencies of a voice communication likely to suffer degradation due to the ambient noise. In one implementation, the power spectrum comparator 106 receives the input signal from the audio input circuitry 110 and applies a fast Fourier transform to translate the input signal from the time domain (e.g., in a form of amplitude v. time) to the frequency domain (e.g., in the form of power v. frequency). The power spectrum comparator 106 then compares the translated input signal (hereinafter referred to as the “input signal power spectrum”) to the predicted noise power spectrum and assesses relativity criteria to determine whether the ambient noise is likely to degrade a voice communication of the input signal at one or more frequency ranges.

In general, a voice communication embodied in the input signal of the microphone 104 is likely to be degraded at frequencies for which the power of the dominant ambient noise is similar to the power of the input signal. For example, the dominant frequency range of a fan may create an audible “hissing” sound that can be captured by the microphone 104. When the power produced in this frequency range is similar to power produced in a same frequency range for a voice communication, the voice communication is likely to be noticeably degraded by the “hissing” fan noise. Thus, one relativity criteria considered by the power spectrum comparator 106 is a similarity between the predicted noise power spectrum and input signal power spectrum. When power of these two spectra are within a pre-defined similarity threshold of one another at one or more common frequency ranges, the power spectrum comparator 106 may determine that the relativity criteria are satisfied and that degradation of the voice communication is likely to occur at such frequencies.

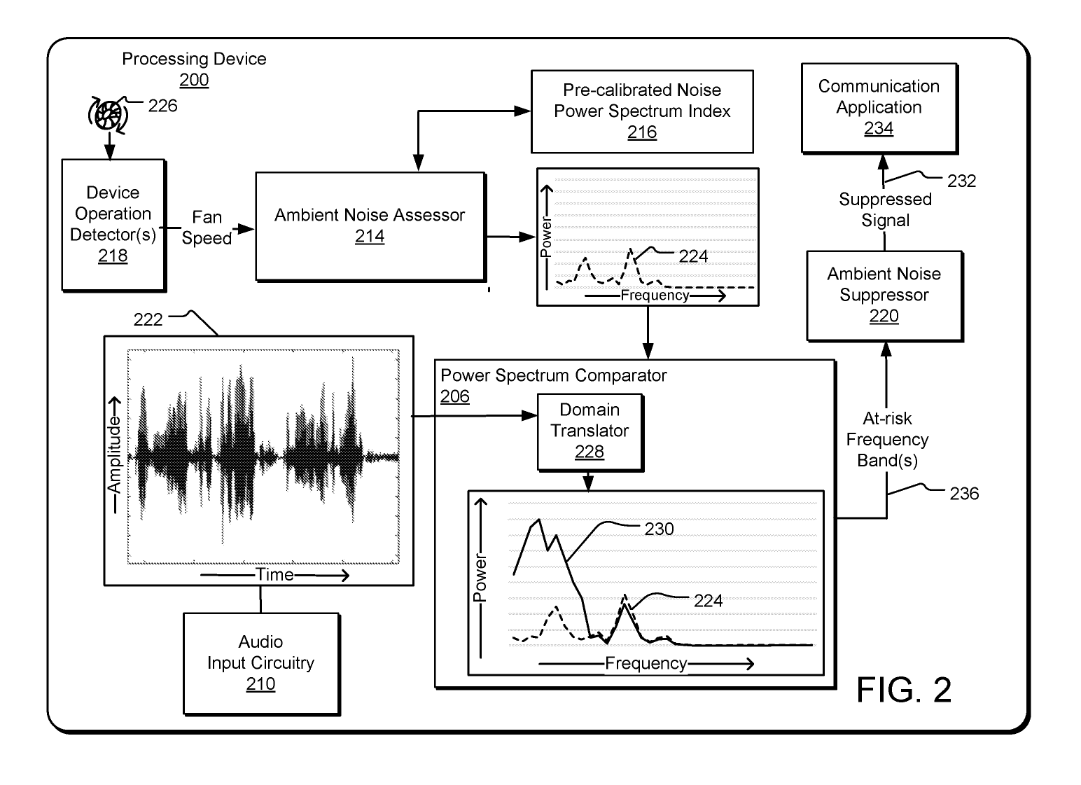

Comparison techniques and relativity criteria may vary widely from one implementation to another based on sound production variability and design characteristics of different electronic devices employing such methodology. More specific examples of relativity criteria and selective frequency suppression are discussed with respect to FIGS. 2-4, below.

The power spectrum comparator 106 identifies one or more frequency bands for suppression based on the above-described comparison and analysis of relativity criteria and provides these identified frequency bands to the ambient noise suppressor 120. In turn, the ambient noise suppressor 120 suppresses the input signal at the identified frequencies. In different implementations, the ambient noise suppressor 120 may use different physical mechanisms to achieve signal suppression. Some of these mechanisms are discussed in greater detail with respect to FIG. 2, below. In some implementations, a select one of the communication application(s) 122 may then transmit the suppressed input signal to another device on a network by way of communication circuitry 124.

In one implementation, the ambient noise assessor 114, power spectrum comparator 106, and ambient noise suppressor 120 are embodied as instructions of a computer operating system. In other implementations, the ambient noise assessor 114, power spectrum comparator 106, and/or ambient noise suppressor 120 are included within the one or more of the communication application(s) 122.

FIG. 2 illustrates an example processing device 200 for suppressing ambient noise from audio input collected from an external environment by audio input circuitry 210. In addition to the audio input circuitry 210, the processing device 200 includes one or more device operation detectors 218 (e.g., a sensor or processor) for providing a parameter of a variable ambient noise source (e.g., a fan 226). In general, the provided parameter facilitates dynamic determination of a power spectrum representative of the variable ambient noise source.

In some implementations, the device operation detectors 218 provide parameters pertaining to multiple discrete ambient noise sources. For example, the processing device 202 may include multiple fans and the device operation detectors 218 may include at least one sensor measuring rotational speed of each different one of the fans. In another implementation, the device operation detectors 218 include a thermal processor that reports a current fan power level from which a current fan speed can be determined. In still another implementation, the processing device 200 includes one or motors that provide power and/or control rotation of a storage media, and the device operation detectors 218 include sensors for measuring vibrations, rotation, or other parameters. In yet one implementation, the device operation detectors 218 include one or more voltage sensors such as for measuring voltage to a device component. For example, changes in voltage to an actuator driving an auto-focus lens or other optical camera elements may be indicative of ambient noise (e.g., due to lens movement), and a power spectrum may be computed based on the voltage measurements.

An ambient noise assessor 214 detects the provided parameter (e.g., the fan speed) from the device operation detectors 218 and uses the detected parameter to determine a predicted noise power spectrum. In FIG. 2, the ambient noise assessor 214 determines the predicted noise power spectrum by locating the detected parameter (or a closest numerical parameter value) in a pre-calibrated noise power spectrum index 216 (e.g., a look-up table) and by retrieving one or more individual power spectra saved in association with the parameter measurement within the pre-calibrated noise power spectrum index 216. If, for example, the detected parameter is a fan speed of an individual fan, the ambient noise assessor 214 may look up the fan speed in a list to identify a corresponding pre-calibrated power spectrum representing power of the associated fan when operating at the detected speed. This identified power spectrum is referenced below and within FIG. 2 as a predicted noise power spectrum 224.

In one implementation, the ambient noise assessor 214 dynamically determines the predicted noise power spectrum 224, such as responsive to initial receipt of input via the audio input circuitry 210 and/or every second or every few milliseconds while audio input is being collected by the audio input circuitry 210.

In some implementations, the device operation detectors 218 provide parameters from multiple discrete ambient noise sources (e.g., fans, motors), and the ambient noise assessor 214 retrieves a pre-calibrated power spectrum in association with each one of the discrete ambient noise sources. For example, the ambient noise assessor 214 retrieves a power spectrum corresponding to each of three fan speeds for three different fans of the processing device 200. In such cases where a power spectra can be determined for each one of multiple discrete sources of ambient noise, the ambient noise assessor 214 may sum together the various determined power spectra and use the resulting spectrum as the predicted noise power spectrum 224.

The ambient noise assessor 214 provides the predicted noise power spectrum 224 to a power spectrum comparator 206, and the power spectrum comparator 206 compares the predicted noise power spectrum 224 to an input power spectrum representative of an input signal 222 received via the audio input circuitry 210. The input signal 222 may, for example, be a time-domain signal (as shown) that is captured via a device microphone. A domain translator 228 of the power spectrum comparator 206 translates the input signal from the time domain (e.g., in a form of amplitude v. time) to the frequency domain (e.g., in the form of power v. frequency). Translation of the input signal 222 to the frequency domain can be performed using a number of suitable transforms including without limitation a fast Fourier Transform, a Discrete Fourier Transform, and a Discrete Wavelet transform. The power spectrum comparator 206 calculates an input power spectrum representative of the input signal 222 based on output of the domain translator 228. In an implementation where the domain translator 228 uses a fast Fourier transform, the input power spectrum is calculated by adding together squared real and imaginary parts of the complex value resulting from the transformation (e.g., the input power spectrum is the magnitude squared of the fast Fourier Transform).

After the domain translator 228 performs this transformation of the input signal 222 to generate a translated input signal 230 in the frequency domain, the power spectrum comparator 206 compares the translated input signal 230 to the predicted noise power spectrum 224 and assesses one or more relativity criteria to determine whether there exist any frequency bands of the voice communication that are “at-risk” of signal degradation due to the ambient noise.

Satisfaction of the relativity criteria may occur in some frequency ranges and not occur in other frequency ranges. In general, the relativity criteria are likely to be satisfied for a given frequency range when the power within that frequency range for the translated input signal 230 is deemed “similar” to the power of the predicted noise power spectrum 224, such as when the power of the two spectrums satisfy a predefined similarity threshold within a common frequency range.

The power spectrum comparator 206 identifies one or more “at-risk” frequency bands 236 for which the relativity criteria is satisfied, and instructs an ambient noise suppressor 220 to perform suppression within the identified frequency bands. In different implementations, the ambient noise suppressor 220 may use different physical mechanisms to achieve suppression of the input signal 222.

In one implementation, the ambient noise suppressor 220 performs suppression on the translated input signal 230 (e.g., in the frequency-domain). For example, the power spectrum comparator 206 provides the ambient noise suppressor 220 with a Fourier series representing the input signal 222 along with the one or more identified frequency ranges for suppression. The ambient noise suppressor 220, in turn, identifies terms of the Fourier series responsible for the identified frequency bands and sets those identified terms to zero or a near-zero value (e.g., by multiplying by 0.01 in case noise reduction is preferred instead of complete noise elimination) before calculating an inverse of the fast Fourier transform to reconstruct the input signal in the time domain. The result is a reconstructed time-domain signal suppressed in the identified frequency bands.

In another implementation, the ambient noise suppressor 220 performs the suppression in the time domain rather than in the frequency domain. For example, the power spectrum comparator 206 provides the ambient noise suppressor 220 with one or more select frequency bands for suppression, and the ambient noise suppressor 120 selectively directs the input signal 222 (e.g., the original, time-domain signal) through one or more band-stop filters to suppress the input signal 222 at the select frequency bands. Regardless of the whether suppression is performed in the time domain or frequency domain, the ambient noise suppressor 220 outputs a suppressed signal 232 that is filtered in the identified, “at-risk” frequency bands 236.

Although the suppressed signal 232 may be used for a variety of purposes in various implementations, the suppressed signal 232 of FIG. 2 is provided to a communication application 234, such as Skype. The communication application 234 may, in turn, transmit the suppressed signal 232 across a network to a third-party device communicating with a user through the communication application 234.

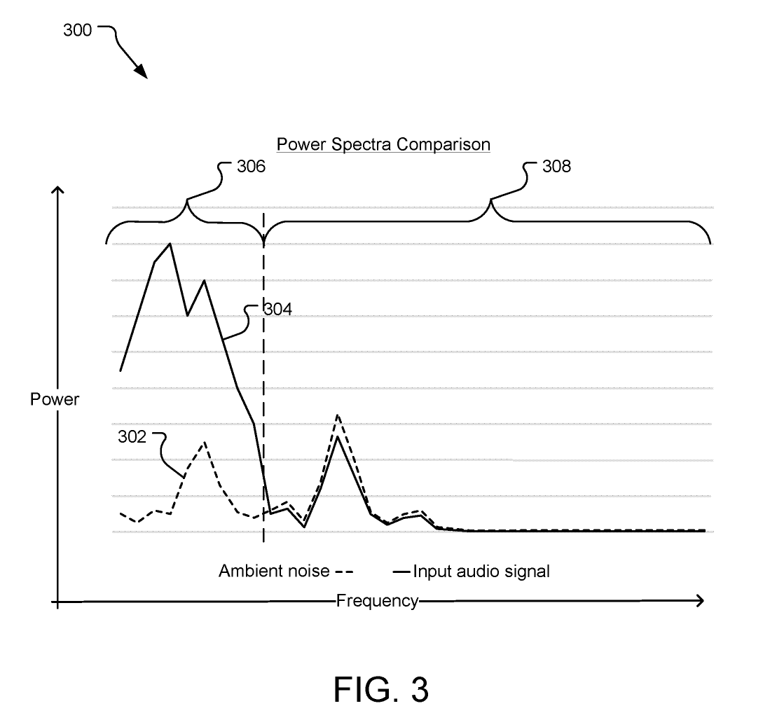

FIG. 3 illustrates an example plot 300 illustrating a first power spectrum corresponding to an ambient noise source (hereinafter “ambient noise power spectrum 302”) and a second power spectrum corresponding to an input signal captured by a microphone (hereinafter “input signal power spectrum 304”). In one implementation, the input signal power spectrum 304 is calculated by performing a fast Fourier transform on a time-domain signal captured by a microphone. The ambient noise power spectrum 302, in contrast, is retrieved from a look-up table stored memory in association with a dynamically-detected parameter of the ambient noise source. For example, the ambient noise power spectrum 302 may be retrieved responsive to receipt of a fan speed by accessing a look-up table including a list of fans speeds, identifying the fan speed from the list, and selecting a pre-calibrated power spectrum saved in association with the fan speed.

As discussed above with respect to FIGS. 1-2, an analysis of relativity criteria may generally facilitate assessment of the risk that a voice communication within the input signal may be degraded due to the presence of ambient noise also present in the input signal. In one implementation, discrete ranges of frequencies are examined independently, and net power is compared for the ambient noise power spectrum 302 and the input signal power spectrum 304 within each discrete frequency range. For example, net power for the two spectra is compared with respect to various frequency ranges spanning a voice frequency range, such as frequencies between 85 to 90 Hz; 90 to 95 Hz; 95 to 100 Hz; etc. If the net power of the input signal power spectrum 304 and the ambient noise power spectrum 302 satisfy a predetermined similarity threshold within one or more of examined discrete frequency ranges, those frequency ranges are identified as “at-risk” for degradation, meaning that a voice communication overlapping those particular frequencies is likely to be degraded by the ambient noise.

In another implementation, net power is examined within discrete frequency ranges (as described above), but the assessment of relativity criteria with respect to one frequency range may further depend on net power observed in one or more other frequency ranges. For example, a frequency range may be considered “at-risk” when power spectra of both the frequency range and the directly-neighboring frequency ranges satisfy one or more thresholds of the relativity criteria.

Specific comparison techniques and select relativity criteria may vary widely from one implementation to another based on sound production variability and design characteristics of different electronic devices employing such methodology. For simplicity, FIG. 3 illustrates two frequency ranges—a first frequency range 306 and a second frequency range 308. These two frequency ranges may be independently analyzed with respect to pre-defined relativity criteria (as discussed further below). Other implementations may provide for independent assessment of a larger number of frequency ranges and/or frequency ranges of narrower breadth.

In the example of FIG. 3, relativity criteria are satisfied when the ambient noise spectrum 302 and the input signal power spectrum 304 are measurably similar (e.g., when the two spectra satisfy a predetermined similarity threshold within a given frequency range). For example, a comparison between the ambient noise power spectrum 302 and the input signal power spectrum 304 may reveal that relativity criteria are not satisfied within a first frequency range 306 but are satisfied within a second frequency range 308. Since a net power of the input signal power spectrum 304 is significantly higher than a net power of the ambient noise power spectrum 302 within the first frequency range 306, there exists a low risk of degradation to a voice signal captured in the input signal for frequencies within the first frequency range 306. Consequently, signal suppression may not be performed within the first frequency range 306.

In contrast, a comparison between the ambient noise power spectrum 302 and the input signal power spectrum 304 may reveal that relativity criteria are satisfied within the second frequency range 308 where the net power of the input signal power spectrum 304 is similar to (e.g., just slightly greater than) a net power of the ambient noise power spectrum 302. Consequently, there exists a significant risk of degradation to a voice communication in the input signal within the second frequency range 308 and signal suppression is performed to suppress frequencies of the input signal within the second frequency range 308.

In general, the relativity criteria are more likely to be satisfied and signal suppression is more likely to be performed when a ratio of net power of the ambient noise spectrum to the input signal spectrum is high for a select frequency range than when the ratio of the net power of the ambient noise spectrum to the input signal is low for the select frequency range. In one example implementation, relativity criteria are satisfied for a given frequency range of when net power of the ambient noise power spectrum 302 is higher than a net power for the input signal power spectrum 304 within that frequency range. In another implementation, the relativity criteria are satisfied for a given frequency range when a ratio of net power of the ambient noise power spectrum 302 to the input signal power spectrum 304 for that frequency range is greater than 25%.

By suppressing the input signal within discrete identified frequency ranges most susceptible to degradation due to the ambient noise, unwanted background noise can be removed and voice communication clarity improved.

In some implementations, relativity criteria are used to determine both a target frequency band for suppression and a strength of noise suppression within the target frequency band. For example, rather than filter an entire frequency band at full strength (e.g., 100% filtering strength), noise suppression may be performed at half the strength, one-quarter of the strength, etc. when the certain conditions are satisfied. In one implementation, signal suppression is performed on a sliding scale (e.g., linearly) depending upon a ratio of the net power of the ambient noise power spectrum 302 to the input signal power spectrum 304. For example, some signal suppression may be performed when the ratio of the net power of the ambient noise power spectrum 302 to the input signal power spectrum 304 is between 0.25 and 0.75, with the amount of the suppression varying from low to high within this range (e.g., suppression at half the strength when the ratio is 0.5).

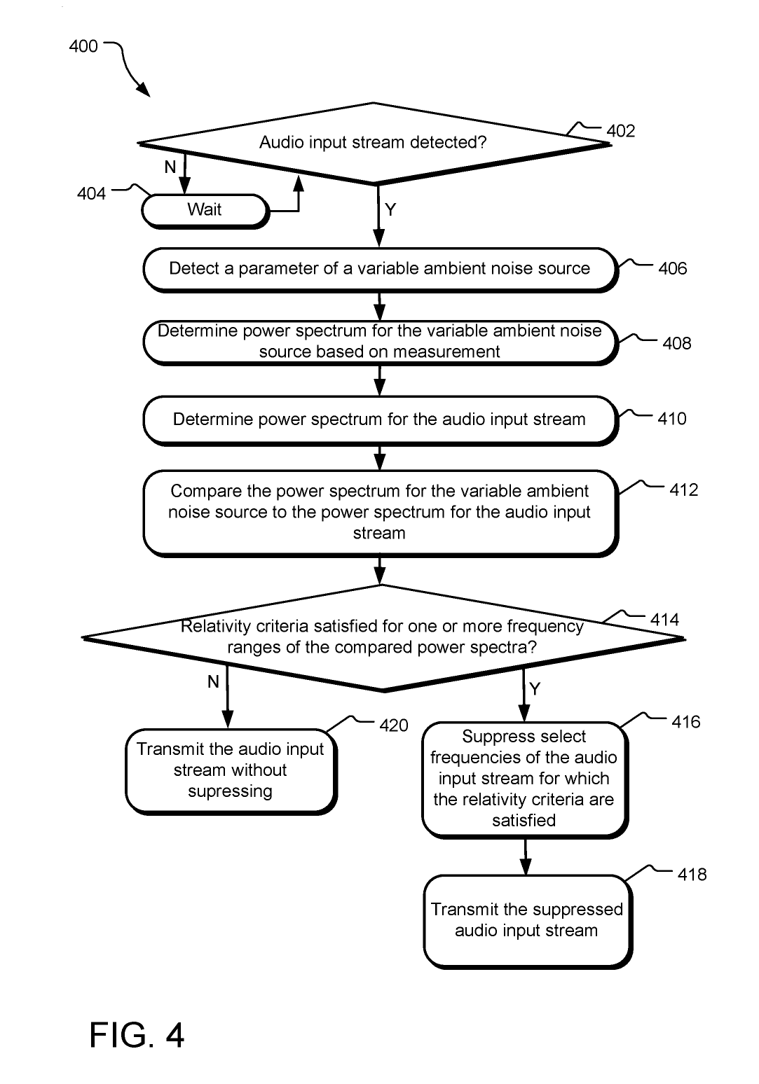

FIG. 4 illustrates example operations 400 for suppressing ambient noise from a voice communication. A determination operation 402 determines whether an audio input stream is currently being received, such through a microphone of an electronic device. If an audio input stream is not currently being received, a waiting operation 404 is entered until an audio input stream is subsequently received. Responsive to receipt of the audio input stream and/or periodically while the audio input stream is actively being received, a detection operation 406 detects a parameter of a variable ambient noise source. For example, the detection operation 406 may receive a current fan power level and/or sensor data to determine a current fan speed. In one implementation, a thermal processor transmits an update each time power to the ambient noise source (e.g., a fan) is increased or decreased. Upon detection, this power update facilitates a real-time assessment and characterization of ambient noise currently being generated by the variable ambient noise source.

Responsive to the detection operation 406, a determination operation 408 determines a power spectrum for the variable ambient noise source that is based on the measurement. In one implementation, the determination operation 408 accesses a table that stores values for the parameter of the ambient noise source in association with pre-calibrated power spectra. For example, the table may store a list of fan speeds and each fan speed may itself be further associated in memory with a pre-calibrated power spectrum. The determination operation 408 selects the pre-calibrated power spectrum that is associated with a parameter value most similar to the detected parameter value attained via the detection operation 406.

In devices with multiple fans and/or other types of ambient noise sources, each of a number of pre-calibrated power spectra may be saved in association with an ambient noise source identifier (e.g., fan #1, fan #2, motor #1) as well as a particular value for the detected parameter (e.g., the fan speed, motor current). For example, fan #1 may be associated in memory with a list of possible rotational speeds and a pre-calibrated power spectrum for each one of the rotational speeds on the list, while fan #2 may be associated in memory with the list of possible rotational speeds and a different pre-calibrated power spectrum for each one of the rotational speeds on the list.

In one implementation, the determination operation 408 determines the power spectrum for the variable ambient noise source by summing together identified power spectra for multiple ambient noise sources concurrently generating noise, such as by first selecting a different power spectrum for each ambient noise source based on a different parameter values detected via the detection operation 406. A number of other suitable operations may also be employed to determine a power spectrum representative of multiple discrete ambient noise sources. For example, various individual power spectra may be averaged or the highest respective values from the individual spectra can be used to determine the power spectrum.

Another determination operation 410 determines a power spectrum corresponding to the input audio stream. In one implementation, the determination operation 410 performs a fast Fourier transform to transform a received input audio stream signal from the time domain to the frequency domain. A power spectrum is then calculated based on this transformed signal and utilized as the power spectrum for the audio input stream.

A comparison operation 412 compares the power spectrum for the ambient noise source to the power spectrum for the input signal, and a determination operation 414 determines whether relativity criteria are satisfied with respect to one or more frequency bands of the compared power spectra. If the relativity criteria are satisfied for one or more identified frequency bands (e.g., as when net power of the power spectra satisfy a similarity threshold within the identified frequency bands), a suppression operation 416 suppresses frequencies of the input audio stream within the identified frequency ranges, and a transmission operation 418 transmits the suppressed audio signal, such as across a network via a communication application.

If the determination operation 414 determines that the relativity criteria are not satisfied for any frequency ranges of the compared power spectra (e.g., as when the net power of the two power spectra do not satisfy the similarity threshold for any frequencies), a transmission operation 420 transmits the audio input stream without suppressing any frequencies.

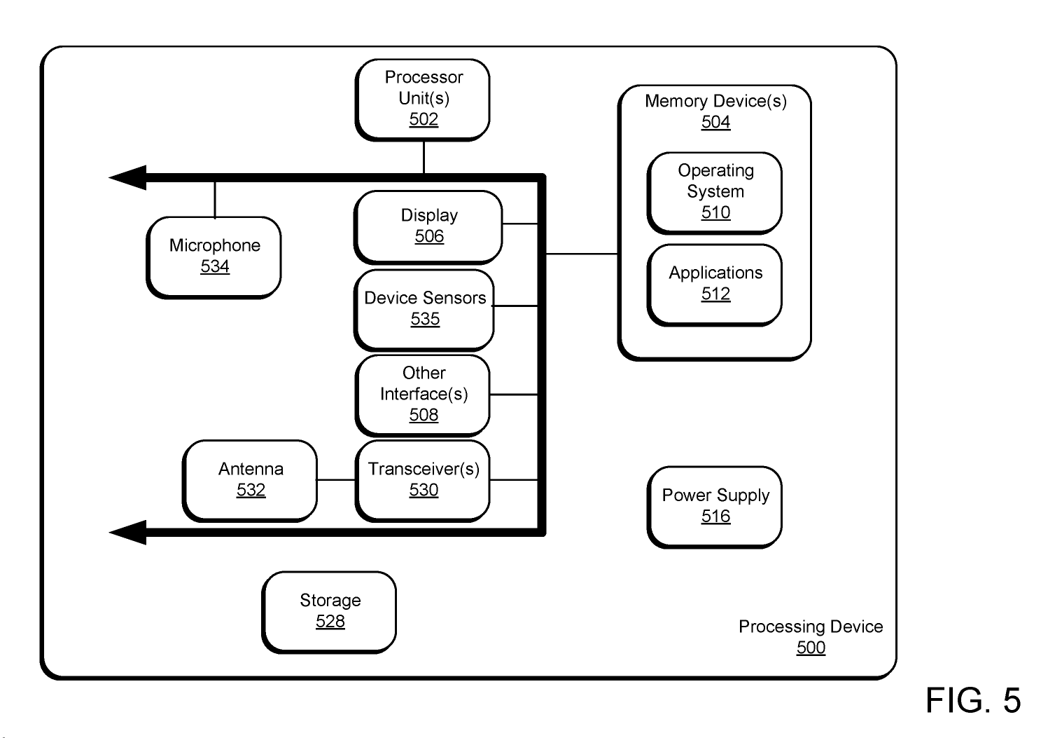

FIG. 5 illustrates an example schematic of a processing device 500 suitable for receiving an audio stream and suppressing ambient noise from the stream in select frequency bands, according to the herein described technology. The example processing device 500 includes one or more processors 502, one or more memory 504, a display 506, and other interfaces 508 (e.g., buttons). The memory 504 generally includes both volatile memory (e.g., RAM) and non-volatile memory (e.g., flash memory). An operating system 510, such as the Microsoft Windows® operating system, the Microsoft Windows® Phone operating system or a specific operating system designed for a gaming device, resides in the memory 504 and is executed by the processor(s) 502, although it should be understood that other operating systems may be employed.

One or more applications 512, such as an ambient noise assessor, power spectrum comparator, ambient noise suppressor and/or various communication applications are loaded in the memory 504 and executed on the operating system 510 by the processor(s) 502. The applications 512 may receive input from a microphone 534 and various device operation sensors 535 as well as input from a display 506 or other interfaces 508 (e.g., a keyboard). The example processing device 500 includes a power supply 516, which is powered by one or more batteries or other power sources and which provides power to other components of the processing device 500.

The processing device 500 includes one or more transceivers 530 and an antenna 532 to provide network connectivity (e.g., a mobile phone network, Wi-Fi®, BlueTooth®, etc.). The processing device 500 may also include various other components, such as a positioning system (e.g., a global positioning satellite transceiver), one or more accelerometers, one or more cameras, other audio interfaces (e.g., an audio amplifier and speaker and/or audio jack), and storage devices 528. Other configurations may also be employed.

In an example implementation, a mobile operating system, various applications (e.g., an ambient noise assessor, power spectrum comparator, ambient noise suppressor and/or various communication applications) may be embodied by instructions stored in memory 504 and/or storage devices 528 and processed by the processor(s) 502. The memory 504 may be memory of host device or of an accessory that couples to a host. Some or all aspects of the processing devices described with respect to FIGS. 1-4, above, may be saved in memory of the processing device 500 (e.g., receiving audio input via the microphone 534) or an external device capable of communicating with the processing device across a network using the antenna 532 and the transceiver(s) 530. For example, pre-calibrated ambient noise power spectra may be stored in the memory 504 of the processing device 500 or one or more external devices that may communicate power spectra information to the processing device 500.

The memory 504 of the processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

A an example method for suppressing ambient noise from a captured audio signal comprises detecting a parameter of a variable ambient noise source; determining a first power spectrum representing the variable ambient noise source based on the detected parameter; determining a second power spectrum representing the captured audio signal; comparing the first power spectrum to the second power spectrum to identify at least one frequency range where net power of the first power spectrum and net power of the second power spectrum satisfy relativity criteria; and suppressing the at least one identified frequency range of the captured audio signal.

In an example method of any preceding method, the relativity criteria are more likely to be satisfied when a ratio of net power of the first power spectrum to the second power spectrum is high for a select frequency range than when the ratio is low for the select frequency range.

Another example method of any preceding method comprises transmitting the suppressed audio signal across a network.

In still another example method of any preceding method, the variable ambient noise source is fan noise and detecting the parameter of the variable ambient noise source further comprises detecting a rotational speed of a fan.

In yet another example method of any preceding method, determining the first power spectrum further comprises: retrieving a power spectrum saved in memory in association with the detected parameter of the variable ambient noise source.

In still another example method of any preceding method, determining the second power spectrum further comprises calculating a fast Fourier transform of the captured audio signal.

In another example method of any preceding method, the fast Fourier transform includes a series of terms and suppressing the at least one identified frequency range further comprises setting one or more of the terms equal to zero.

In another example method of any preceding method, suppressing the at least one identified frequency range further comprises filtering the captured audio signal with one or more band stop filters.

An example system comprises an ambient noise assessor stored in memory and executable by a processor to detect a parameter of a variable ambient noise source and determine a first power spectrum representing the variable ambient noise source based on the detected parameter. The system further comprises a comparator stored in the memory and executable to determine a second power spectrum representing a captured audio signal and to compare the first power spectrum to the second power spectrum to identify at least one frequency range where net power of the first power spectrum and net power of the second power spectrum satisfy relativity criteria. The system additionally includes a noise suppressor stored in the memory and executable by the processor to suppress the at least one identified frequency range of the captured audio signal.

In an example system of any preceding system, the relativity criteria are more likely to be satisfied when a ratio of net power of the first power spectrum to the second power spectrum is high for a select frequency range than when the ratio is low for the select frequency range.

In another example system of any preceding system the system further comprises a communication application stored in the memory and executable by the processor to control communication circuitry to transmit the suppressed captured audio signal across a network.

In still another example system of any preceding system, the variable ambient noise source is fan noise and the ambient noise assessor is further executable to detect a rotational speed of a fan and determine a corresponding power spectrum based on the detected rotational speed.

In another example system of any preceding system, the comparator is executable to determine the first power spectrum by retrieving a power spectrum saved in memory in association with the detected rotational fan speed.

In still another example system of any preceding system, the comparator is executable to determine the second power spectrum by performing a fast Fourier transform of the captured audio signal.

In another example system of any preceding system, the fast Fourier transform includes a series of terms and the noise suppressor suppresses the at least one identified frequency range further by setting one or more of the terms equal to zero.

In yet another example system of any preceding system, the noise suppressor is configured to suppress the at least one identified frequency range by filtering the captured audio signal with one or more band stop filters.

An example system comprises a means for detecting a parameter of a variable ambient noise source and a means for determining a first power spectrum representing the variable ambient noise source based on the detected parameter. The system further comprises a means for determining a second power spectrum representing a captured audio signal and a means for comparing the first power spectrum to the second power spectrum to identify at least one frequency range where net power of the first power spectrum and net power of the second power spectrum satisfy relativity criteria. The system still further comprises a means for suppressing the at least one identified frequency range of the captured audio signal.

An example tangible processor-readable storage media of a tangible article of manufacture encodes computer-executable instructions for executing on a computer system a computer process. The example computer process comprises detecting a parameter of a variable ambient noise source; determining a first power spectrum representing the variable ambient noise source based on the detected parameter; determining a second power spectrum representing a captured audio signal; comparing the first power spectrum to the second power spectrum to identify at least one frequency range where net power of the first power spectrum and net power of the second power spectrum satisfy relativity criteria; and suppressing the at least one identified frequency range of the captured audio signal.

In an example computer process of any preceding computer process, the relativity criteria are more likely to be satisfied when a ratio of net power of the first power spectrum to the second power spectrum is high for a select frequency range than when the ratio is low for the select frequency range.

In still another example computer process of any preceding computer process, the computer process further comprises transmitting the suppressed captured audio signal across a network.

In still another example computer process of any preceding computer process, the variable ambient noise source is fan noise and detecting the parameter of the variable ambient noise source further comprise detecting a rotational speed of a fan

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

1. A method for suppressing ambient noise from a captured audio signal, the method comprising:
detecting a parameter of a variable ambient noise source;
determining a first power spectrum representing the variable ambient noise source based on the detected parameter, the first power spectrum being determined independent of the captured audio signal;
determining a second power spectrum representing the captured audio signal;
comparing the first power spectrum to the second power spectrum to identify at least one frequency range where net power of the first power spectrum and net power of the second power spectrum satisfy relativity criteria; and
suppressing the at least one identified frequency range of the captured audio signal by an amount linearly proportional to a ratio of the first power spectrum to the second power spectrum.

2. The method of claim 1, wherein the relativity criteria are more likely to be satisfied when a ratio of net power of the first power spectrum to the second power spectrum is high for a select frequency range than when the ratio is low for the select frequency range.

3. The method of claim 1, further comprising
transmitting the suppressed audio signal across a network.

4. The method of claim 1, wherein the variable ambient noise source is fan noise and detecting the parameter of the variable ambient noise source further comprises:
detecting a rotational speed of a fan.

5. The method of claim 1, wherein determining the first power spectrum further comprises:
retrieving a power spectrum saved in memory in association with the detected parameter of the variable ambient noise source.

6. The method of claim 1, wherein determining the second power spectrum further comprises:
calculating a fast Fourier transform of the captured audio signal.

7. The method of claim 6, wherein the fast Fourier transform includes a series of terms and suppressing the at least one identified frequency range further comprises setting one or more of the terms equal to zero.

8. The method of claim 1, wherein suppressing the at least one identified frequency range further comprises filtering the captured audio signal with one or more band stop filters.

9. A system for suppressing ambient noise from a captured audio signal comprising:
an ambient noise assessor stored in memory and executable by a processor to detect a parameter of a variable ambient noise source and determine a first power spectrum representing the variable ambient noise source based on the detected parameter, the first power spectrum being determined independent of the captured audio signal;
a comparator stored in the memory and executable by the processor to:
determine a second power spectrum representing the captured audio signal; and
compare the first power spectrum to the second power spectrum to identify at least one frequency range where net power of the first power spectrum and net power of the second power spectrum satisfy relativity criteria; and
a noise suppressor stored in the memory and executable by the processor to suppress the at least one identified frequency range of the captured audio signal by an amount linearly proportional to a ratio of the first power spectrum to the second power spectrum.

10. The system of claim 9, wherein the relativity criteria are more likely to be satisfied when a ratio of net power of the first power spectrum to the second power spectrum is high for a select frequency range than when the ratio is low for the select frequency range.

11. The system of claim 9, further comprising:
a communication application stored in the memory and executable by the processor to control communication circuitry to transmit the suppressed captured audio signal across a network.

12. The system of claim 9, wherein the variable ambient noise source is fan noise and the ambient noise assessor is further executable to detect a rotational speed of a fan and determine a corresponding power spectrum based on the detected rotational speed.

13. The system of claim 12, wherein the comparator is executable to determine the first power spectrum by retrieving a power spectrum saved in memory in association with the detected rotational fan speed.

14. The system of claim 9, wherein the comparator is executable to determine the second power spectrum by performing a fast Fourier transform of the captured audio signal.

15. The system of claim 14, wherein the fast Fourier transform includes a series of terms and the noise suppressor suppresses the at least one identified frequency range further by setting one or more of the terms equal to zero.

16. The system of claim 9, wherein the noise suppressor is configured to suppress the at least one identified frequency range by filtering the captured audio signal with one or more band stop filters.

17. One or more storage devices encoding computer-executable instructions for executing on a computer system a computer process for suppressing ambient noise from a captured audio signal, the computer process comprising:
detecting a parameter of a variable ambient noise source;
determining a first power spectrum representing the variable ambient noise source based on the detected parameter, the first power spectrum being determined independent of the captured audio signal;
determining a second power spectrum representing the captured audio signal;
comparing the first power spectrum to the second power spectrum to identify at least one frequency range where net power of the first power spectrum and net power of the second power spectrum satisfy relativity criteria; and
suppressing the at least one identified frequency range of the captured audio signal by an amount linearly proportional to a ratio of the first power spectrum to the second power spectrum.

18. The one or more storage devices of claim 17, wherein the relativity criteria are more likely to be satisfied when a ratio of net power of the first power spectrum to the second power spectrum is high for a select frequency range than when the ratio is low for the select frequency range.

19. The one or more storage devices of claim 17, wherein the computer process further comprises:
transmitting the suppressed captured audio signal across a network.

20. The one or more storage devices of claim 17, wherein the variable ambient noise source is fan noise and detecting the parameter of the variable ambient noise source further comprises:
detecting a rotational speed of a fan.
